(19) United States
(12) Patent Application Publication
(10) Pub. No.: US 2015/0067281 A1
(43) Pub. Date: Mar. 5, 2015

(54) RESERVATION OF STORAGE SPACE FOR A THIN PROVISIONED VOLUME

(71) Applicant: International Business Machines Corporation, Armonk, NY (US)

(72) Inventors: Carl E. Jones, Tucson, AZ (US); Subhojit Roy, Pune (IN); Gail A. Spear, Tucson, AZ (US)

(21) Appl. No.: 14/018,877

(22) Filed: Sep. 5, 2013

(51) Int. Cl. G06F 12/02

(52) U.S. Cl. CPC G06F 12/0284
USPC 711/156

(57) ABSTRACT

For reserving storage space, a determination module determines if required storage space is available for a write in response to logical storage address for the write being unallocated. The logical storage address is a thin provisioned storage space. A reservation module reserves the required storage space for the write in response to determining that the required storage space is available. In addition, the reservation module may communicate an allocation success in response to determining the required storage space is available. The allocation success is communicated prior to allocating the required storage space. The reservation module may communicate a write failure in response to determining the required storage space is not available.

### FIELD

The subject matter disclosed herein relates to reserving storage space and more particularly relates to reserving storage space for a thin provisioned volume.

### BACKGROUND

1. Description of the Related Art

A storage volume may be thinly provisioned, with storage space only allocated for data that is actually written to the storage volume.

2. Brief Summary

An apparatus for reservation of storage space is disclosed. The apparatus includes a determination module and reservation module. The determination module determines if required storage space is available for a write in response to physical storage space for the write being unallocated. The logical storage address is a thin provisioned storage space. The reservation module reserves the required storage space for the write in response to determining that the required storage space is available. In addition, the reservation module may communicate an allocation success in response to determining the required storage space is available. The allocation success is communicated prior to allocating the required storage space. The reservation module may communicate a write failure in response to determining the required storage space is not available. A method and computer program product also perform the functions of the apparatus.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a storage system;

FIG. 2 is a schematic block diagram illustrating one alternate embodiment of the storage system;

FIGS. 3A-B are schematic block diagrams illustrating embodiments of thin provisioned storage space;

FIG. 4A is a schematic block diagram illustrating one embodiment of a provisioning map entry;

FIG. 4B is a schematic block diagram illustrating one embodiment of a reservation;

FIG. 5 is a schematic block diagram illustrating one embodiment of a provisioning map;

FIG. 6 is a schematic block diagram illustrating one embodiment of a computer;

FIG. 7 is a schematic block diagram illustrating one embodiment of a reservation apparatus;

FIG. 8 is a schematic flow chart diagram illustrating one embodiment of a reservation method; and

FIG. 9 is a schematic flow chart diagram illustrating one embodiment of a batch reservation method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

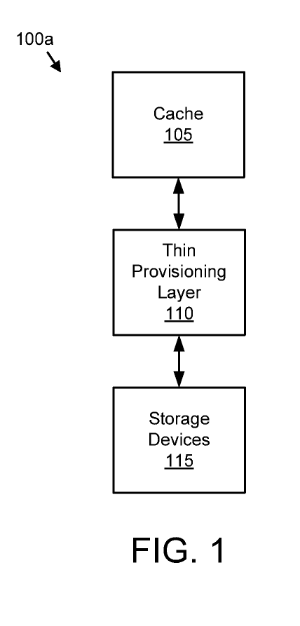

FIG. 1 is a schematic block diagram illustrating one embodiment of a storage system 100a. The system 100a includes a cache 105, a thin provisioning layer 110, and storage devices 115. The cache 105 may receive writes of data from one or more applications, hosts, or the like for the storage devices 115. The writes may be directed to a logical volume. The logical volume may comprise storage space from the storage devices 115.

The thin provisioning layer 110 may allow the logical volume to be represented as having a very large storage space. For example, the thin provisioning layer 110 may represent the logical volume as having 100 terabytes (TB) of storage space. However, only a small portion of the 100 TB of storage space may actually be allocated from the storage devices 115.

When the cache 105 receives a write directed to the thin provisioned storage space for which no physical storage space has been allocated, the thin provisioning layer 110 must allocate storage space from the storage devices 115 before the write can be completed. Unfortunately, allocating the storage space for the write may require considerable time. As a result, the system 100a may complete the write after a lengthy delay. In addition, the system 100a must wait to communicate to the application or host that the write was successful. As a result, the application or host may be delayed in completing other tasks.

In the past, in order to avoid delays for the application and/or host, the thin provisioning layer 110 may communicate that a write to an unallocated logical storage address is successful, allowing the application and/or host to continue other tasks. Unfortunately, if the thin provisioning layer 110 is subsequently unable to allocate required storage space for the writes, the write may fail and the data in the storage devices 115 will not reflect the write. For example, a read to a logical storage address for which no physical storage space was allocated may return all zeros rather than any data that was to have been written as part of a failed write. Alternatively, if available storage space is calculated as total physical storage less cache capacity, and fail a write if the available capacity is insufficient for the write.

The embodiments described herein reserve physical storage space for a write to a thin provisioned storage volume as will be described hereafter. As a result, writes to the thin provisioned storage space may be reliably acknowledged as written successfully prior to allocating the required storage space for the write. The application and/or host writing to the storage system 100a may therefore continue with other tasks while the system 100a allocates the required storage space for the write and completes the write with minimal risk of a subsequent write failure from the cache (105).

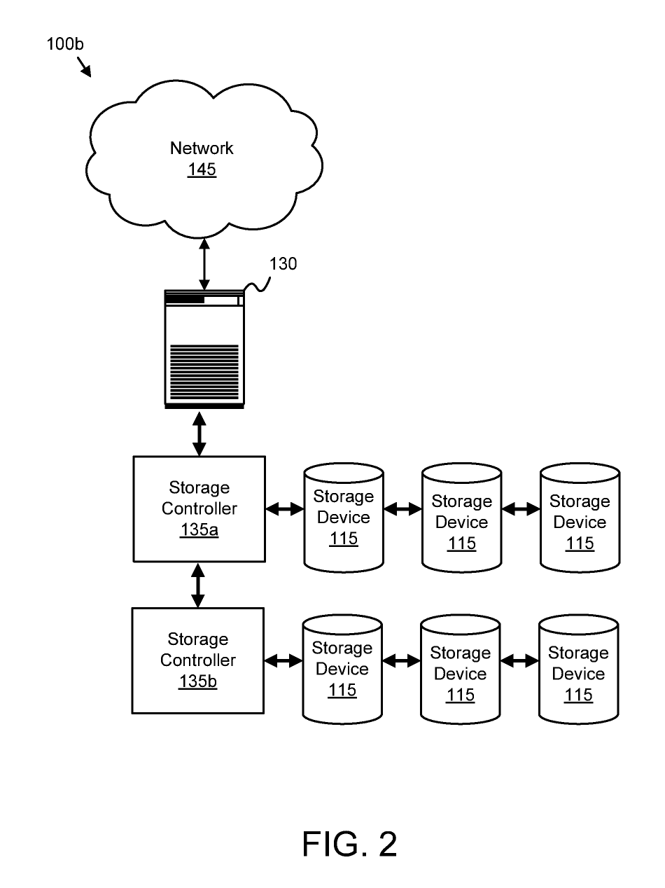

FIG. 2 is a schematic block diagram illustrating one alternate embodiment of the storage system 100b. The system 100b includes the network 145, a server 130, one or more storage controllers 135, and one or more storage devices 115. In one embodiment, the server 130 embodies the cache 105 of FIG. 1. The server 130 may receive writes from the network 145, cache the writes in the server's internal memory, and communicate the writes to the storage controllers 135. The server 130, the storage controllers 135, or combinations therefore may embody the thin provisioning layer 110. The storage controllers 135 may complete a write to the system 100b by writing data to a storage device 115.

In one embodiment, storage space in the storage devices 115 is allocated for data that has been written to the thin provisioned logical volume. The allocated storage space for the logical volume is less than addressable storage space for the logical volume as will be shown hereafter. As a result, the logical volume has logical storage address that an application and/or host may write to but that is not yet been allocated physical storage space in the storage devices 115.

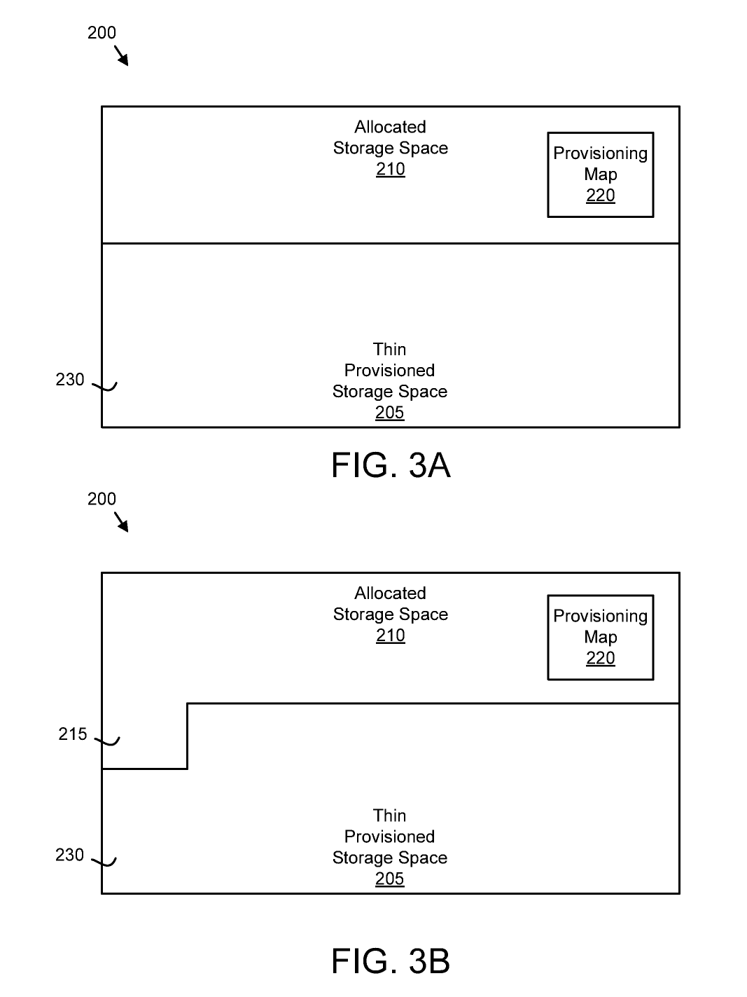

FIGS. 3A-B are schematic block diagrams illustrating embodiments of thin provisioned storage space 205. FIG. 3A depicts the thin provisioned storage space 205. The thin provisioned storage space 205 is the logical storage address of the thin provisioned logical volume that is seen by an application and/or host. For example, the thin provisioned storage space 205 may appear to include 10 GB of storage space to an application. However, only a portion of the thin provisioned storage space 205 is allocated physical storage space in the storage devices 115, the allocated storage space 210. For example, only 1 GB of thin provisioned storage space 205, the allocated storage space may be physical storage space of the storage devices 115. A provisioning map 220 catalogs the allocated storage space 210 and/or unallocated storage space 230 of the thin provisioned storage space 205.

FIG. 3B depicts allocating physical storage space for a logical volume. When a write is directed to a logical storage address that is unallocated, storage space is allocated for the data of the write. In addition, the provisioning map 220 is updated to catalog the newly allocated storage space 215 that is associated with the logical storage address.

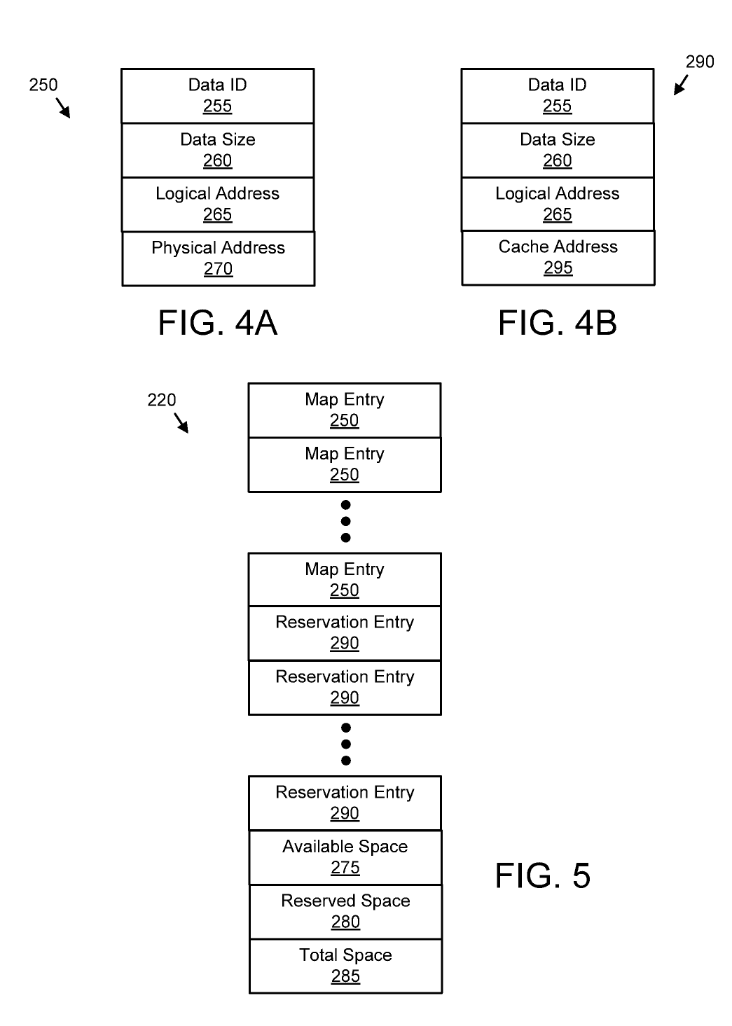

FIG. 4A is a schematic block diagram illustrating one embodiment of a provisioning map entry 250. The provisioning map entry 250 may be added to the provisioning map 220 when storage space is allocated for the data of a write. The provisioning map entry 250 includes a data identifier 255, a data size 260, a logical address 265, and a physical address 270.

The data identifier 255 may uniquely identify the data referenced by the provisioning map entry 250 that is stored in the allocated storage space 210. In one embodiment, the data identifier 255 is a logical name. The data size 260 may specify a number of the bytes comprising the data. Alternatively, the data size 260 may specify the storage space occupied by the data.

The logical address 265 may be an address used by an application and/or host to access the data of the provisioning map entry 250. The logical address 265 may use absolute addressing, relative addressing, or the like. The physical address 270 may be an address of the storage devices 115 corresponding to the logical address 265. Thus the provisioning map entry 250 may map the logical address 265 to the physical address 270.

FIG. 4B is a schematic block diagram illustrating one embodiment of a reservation entry 290. The reservation entry 290 may reserve unallocated storage space 230 in the storage devices 115 for write data directed to a logical storage address that is not yet allocated in the allocated storage space 210 of the thin provisioned storage space 205. The reservation entry 290 includes the data identifier 255, the data size 260, and the logical address 265 of the provisioning map entry 250 of FIG. 4A.

FIG. 5 is a schematic block diagram illustrating one embodiment of the provisioning map 220. The provisioning map 220 includes one or more provisioning map entries 250 and one or more reservations 290. In addition, the provisioning map 220 includes an available storage space 275, a reserved storage space 280, and a total storage space 285. The provisioning map 220 may be stored in a memory or may be stored on disk and paged into memory as needed. The provisioning map 220 may be organized as a database, a link list of data structures, a flat file, and the like.

The total storage space 285 may be set by an administrator. The available storage space 275 may describe unallocated storage space 230 in the storage devices 115 that is available for allocation to the thin provisioned storage space 205. For example, if 12 TB of storage space 230 is unallocated and available in the storage devices 115 for allocation to the thin provisioned storage space 205, the available storage space 275 may be 12 TB. In one embodiment, the reserved storage space 280 describes the quantity of the available storage space 275 that has been reserved for writes to the thin provisioned storage space 205. For example, if required storage space that has been reserved for one or more writes but that has not yet been allocated from the storage devices 115 totals 500 megabytes (MB), the reserved storage space 280 is 500 MB. In one embodiment, the reserved storage space 280 is the sum of the data size 260 for each reservation entry 290.

The reservation entries 290 may record reservations that have not been completed. In one embodiment, the reservation entries 290 are processed as a batch as will be discussed hereafter.

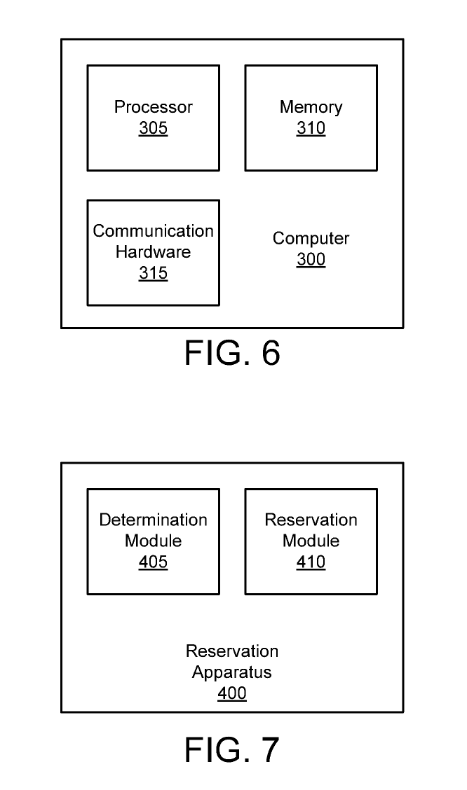

FIG. 6 is a schematic block diagram illustrating one embodiment of a computer 300. One or more computers 300 may be embodied in one or more of the cache 105, the thin provisioning layer 110, and the storage devices 115 of FIG. 1. Alternatively, one or more computers 300 may be embodied in one or more of the server 130, the storage controllers 135, and the storage devices 115 of FIG. 2.

The computer 300 includes a processor 305, a memory 310, and communication hardware 315. The memory 310 may be a semiconductor storage device, a hard disk drive, an optical storage device, a micromechanical storage device, or combinations thereof. The memory 310 may store program code. The program code may be readable/executable by the processor 305. The communication hardware 315 may communicate with other devices.

FIG. 7 is a schematic block diagram illustrating one embodiment of a reservation apparatus 400. The apparatus 400 may be embodied in one or more of the cache 105, the thin provisioning layer 110, and the storage devices 115 of FIG. 1. Alternatively, the apparatus 400 may be embodied in one or more of the server 130, the storage controllers 135, and the storage devices 115 of FIG. 2. In a certain embodiment, the apparatus 400 is embodied in one or more computers 300.

The apparatus 400 includes a determination module 405 and a reservation module 410. The determination module 405 and the reservation module 410 may comprise one or more of hardware and program code. The hardware may be semiconductor gates in a semiconductor device, discrete components organized on a circuit board, or combinations thereof. The program code may be stored on one or more computer readable storage media such as the memory 310.

The determination module 405 determines if required storage space is available for a write in response to logical storage address for the write being unallocated. The logical storage address is within the thin provisioned storage space 205.

The reservation module 410 reserves the required storage space for the write in response to determining that the required storage space is available. In addition, the reservation module 410 communicates an allocation success in response to determining if the required storage space is available. The allocation success is communicated prior to allocating the required storage space in the thin provisioned storage space 205.

However, the reservation module 410 may communicate an allocation failure in response to determining that the required storage space is not available. In addition, the reservation module 410 may mitigate the allocation failure as will be described hereafter.

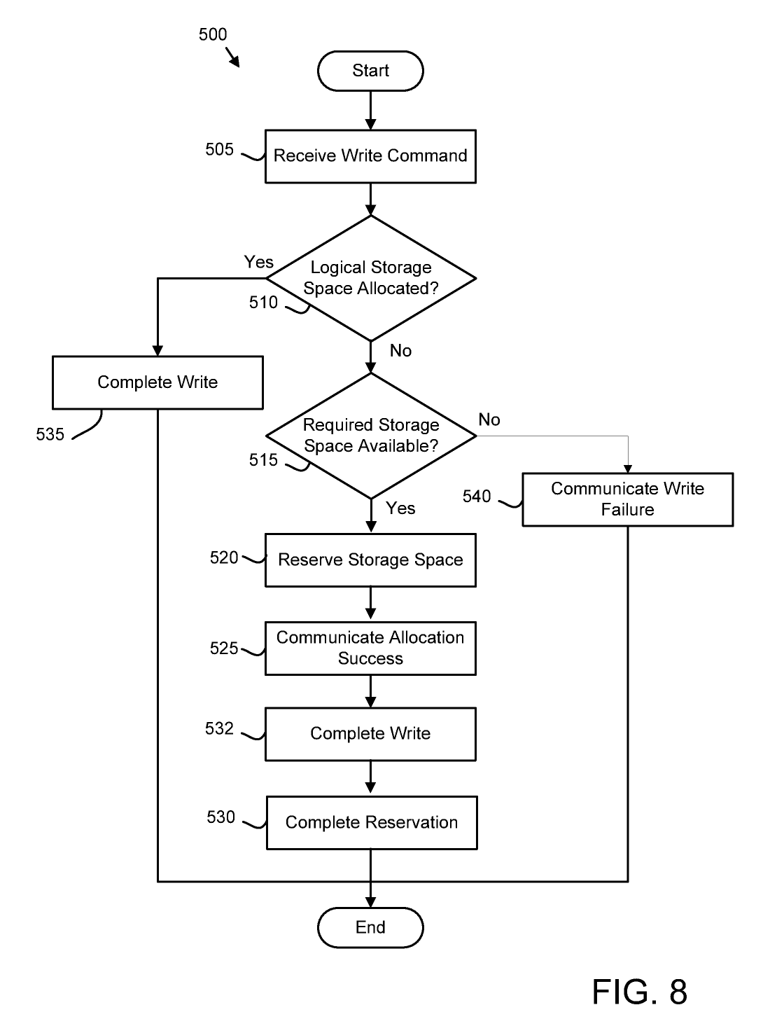

FIG. 8 is a schematic flow chart diagram illustrating one embodiment of a reservation method 500. The method 500 may be performed by the systems 100, the computer 300, and/or the apparatus 400. In one embodiment, the method 500 is performed by the processor 305. Alternatively, the method 500 may be performed by a computer program product comprising a computer readable storage medium such as the memory 310. The computer readable storage medium may have program code embedded thereon. The program code may be readable/executable by the processor 305 to perform the functions of the method 500.

The method 500 starts, and in one embodiment, the determination module 405 receives 505 a write request. The write request may be directed to a logical storage address in the thin provisioned storage space 205. The write may include data to be written to the storage devices 115. In one embodiment, the write may be initially stored in the cache 105.

The determination module 405 may determine 510 if the logical storage address for the write is allocated. In one embodiment, the determination module 405 accesses the provisioning map 220 to determine 510 if the physical storage space for the write is allocated. For example, if the write is directed to a first logical address 265, the determination module 405 may use the first logical address 265 as an index for the provisioning map 220 to determine if there is a corresponding physical address 270 for the write.

If there is a corresponding physical address 270 to the first logical address 265, the logical storage address for the write is allocated. However, if there is no corresponding physical address 272 for the first logical address 265 and/or no provisioning map entry 250 for the first logical address 265, the determination module 405 may determine 510 that the physical storage space for the write is not allocated. In a certain embodiment, the determination module 405 may only determine 510 whether the physical storage space is allocated if reserving a physical storage space fails.

If the logical storage address for the write is allocated, the determination module 405 may complete 535 the write of the data of the write to the corresponding physical address 270 in the allocated storage space 210 and the method 500 ends. If the logical storage address for the write is not allocated, the determination module 405 may determine 515 if the required storage space is available for the write.

In one embodiment, the determination module 405 determines 515 if the required storage space is available in response to the required storage space RS being less than the available storage space AS 275 less the reserved storage space VS 280 as illustrated in Equation 1.

RS<AS−VS Equation 1

If the required storage space is not available, the determination module 405 may communicate 540 a write failure and the method 500 ends. The write failure may be communicated 540 to the application and/or host that initiated the write.

If the required storage space is available, the reservation module 410 may reserve 520 the required storage for the write. In one embodiment, the reservation module 410 reserves the required storage space for the write by creating a reservation entry 290 and appending the reservation entry 290 to the provisioning map 220. In addition, the reservation module 410 may increment the reserved storage space 280 by the data size 260 of the reservation entry 290.

Because the required storage space is reserved, the reservation module 410 may communicate 525 an allocation success to the cache 105. The cache 105 caches the write data and communicates a write success to the application and/or host requesting the write with high confidence that there is sufficient storage space available for allocation for the write data. As a result, the allocation success is communicated rapidly and prior to actual allocating the required storage space for the write in the allocated storage space 210 of the thin provisioned storage space 205.

The determination module 405 may complete 532 the write. In one embodiment, the determination module 405 may communicate a write success to an application and/or host requesting the write.

The reservation module 410 may further complete 530 the reservation of the required storage space for the write subsequent to completing 532 the write. In one embodiment, the reservation module 410 allocates storage space from unallocated storage space 230 of the storage devices 115 and includes the newly allocated storage space in the allocated storage space 210 of the thin provisioned storage space 205. In addition, the reservation module 410 may convert the reservation entry 290 for the write into a provisioning map entry 250. Because the allocation of the storage space is performed after the communication 525 of the allocation success, the application and/or host making the write is not delayed, but can continue processing other tasks.

By reserving 520 storage space if the required storage space is available, the method 500 allows a allocation success to be reliably communicated 525 for the write before the completion 530 of the reservation and the allocation of the required storage space for the write. As a result, the completion of the writes as seen by the application and/or host is accelerated with reduced risk of a subsequent write failure when the cache eventually flushes the cached data to the virtual disk.

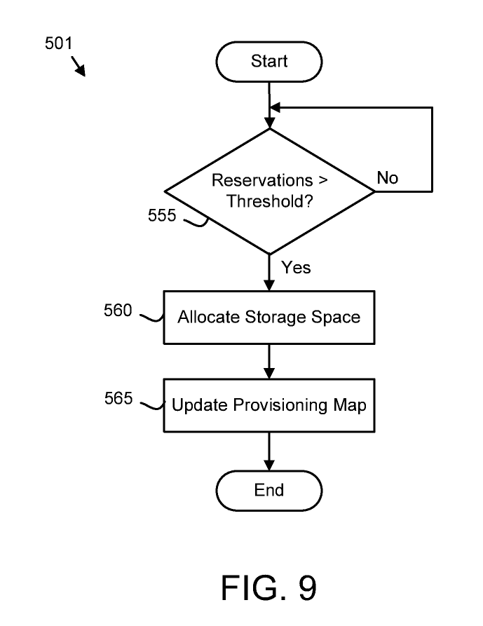

FIG. 9 is a schematic flow chart diagram illustrating one embodiment of a batch reservation method 501. The method 501 may be performed by the systems 100, the computer 300, and/or the apparatus 400. In one embodiment, the method 500 is performed by the processor 305. Alternatively, the method 501 may be performed by a computer program product comprising a computer readable storage medium such as the memory 310. The computer readable storage medium may have program code embedded thereon. The program code may be readable/executable by the processor 305 to perform the functions of the method 501.

In one embodiment, the method 501 is embodied in the complete reservation step 530 of FIG. 8. The method 501 starts, and in one embodiment the reservation module 410 determines 555 if existing reservations for required storage space exceed a reservation threshold. In a certain embodiment, the reservation threshold is a number of reservation entries 290. The reservations may exceed the reservation threshold if the reservation entries 290 in the provisioning map 220 exceed the reservation threshold. Alternatively, the reservation threshold may be a quantity of data. The reservations may exceed the reservation threshold if a sum of the data sizes 260 for the reservation entries 290 exceeds the quantity of data for the reservation threshold.

If reservations for required storage space do not exceed the reservation threshold, the reservation module 410 may continue to determine 555 if reservations exceed the reservation threshold until reservations exceed the reservation threshold. As a result, completions of reservations may be performed as a batch.

If reservations for required storage space exceed the reservation threshold, the reservation module 410 may allocate 560 the required storage space for the write from the storage devices 115 and append the newly allocated storage space 215 to the allocated storage space 210 of the thin provisioned storage space 205.

In addition, the reservation module 410 may update 565 the provisioning map 220. In one embodiment, the reservation module 410 converts the reservation entries 290 into provisioning map entries 250. The reservation module 410 may convert the reservation entries 290 by changing indicators such as a flag and by replacing the cache address 295 with the physical address 270 of the data in the storage devices 115.

By completing the reservations of the required storage for the writes as a batch reserve, the method 501 may more efficiently complete the reservations as larger blocks of storage space may be allocated at the same time and by writing and/or modifying multiple provisioning map entries 250 as a block. As a result, the allocation of storage space for unallocated writes is completed more efficiently and rapidly. [If this was not done, the cache layer would select the destaging of cached data based on its own algorithm and as a result large chunks of address space may not be allocated sequentially, resulting in inefficient space allocation, thus slowing space allocation.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a determination module determining if required storage space is available for a write in response to physical storage space for the write being unallocated, wherein the logical storage address is a thin provisioned storage space;
a reservation module reserving the required storage space for the write in response to determining that the required storage space is available, communicating an allocation success in response to determining the required storage space is available prior to allocating the required storage space, and communicating a write failure in response to determining that the required storage space is not available; and
wherein at least a portion of the determination module and reservation module comprise one or more of hardware and program code, the program code stored on one or more computer readable storage media.

2. The apparatus of claim 1:
the determination module completing the write; and
the reservation module further completing the reservation of the required storage space subsequent to completion of the write.

3. The apparatus of claim 2, wherein completing the reservation of the storage space comprises:
allocating the required storage space for the write; and
updating a provisioning map with the allocated storage space.

4. The apparatus of claim 2, wherein the reservation of the required storage space is completed in a batch reserve for a plurality of required storage spaces.

5. The apparatus of claim 1, the determination module further:
receiving the write; and
determining if the logical storage address for the write is already allocated.

6. The apparatus of claim 1, wherein storage space in the thin provisioned storage space is unallocated prior to a write to the storage space.

7. The apparatus of claim 1, wherein storage space in the thin provisioned storage space is unallocated prior to a write to the storage space.

8. A method for reservation of storage space comprising:
determining, by use of a processor, if required storage space is available for a write in response to logical storage address for the write being unallocated, wherein the logical storage address is a thin provisioned storage space;
reserving the required storage space for the write in response to determining that the required storage space is available;
communicating a allocation success in response to determining the required storage space is available prior to allocating the required storage space; and
communicating a write failure in response to determining that the required storage space is not available.

9. The method of claim 8, further comprising:
completing the write; and
completing the reservation of the required storage space subsequent to completion of the write.

10. The method of claim 9, wherein completing the reservation of the storage space comprises:
allocating the required storage space for the write; and
updating a provisioning map with the allocated storage space.

11. The method of claim 9, wherein the reservation of the required storage space is completed in a batch reserve for a plurality of required storage spaces.

12. The method of claim 8, further comprising:
receiving the write; and
determining if the logical storage address for the write is allocated.

13. The method of claim 8, further comprising writing data for the write from a cache to an allocated storage space.

14. The method of claim 8, further comprising recording uncompleted reservations.

15. The method of claim 8, wherein storage space in the thin provisioned storage space is unallocated prior to a write to the storage space.

16. A computer program product reservation of storage space, the computer program product comprising a computer readable storage medium having program code embodied therein, the program code readable/executable by a processor to:
determining if required storage space is available for a write in response to logical storage address for the write being unallocated, wherein the logical storage address is a thin provisioned storage space;
reserving the required storage space for the write in response to determining that the required storage space is available;
communicating a allocation success in response to determining the required storage space is available prior to allocating the required storage space; and
communicating a write failure in response to determining that the required storage space is not available.

17. The computer program product of claim 16, the program code further:
completing the write; and
completing the reservation of the required storage space subsequent to completion of the write.

18. The computer program product of claim 17, wherein completing the reservation of the storage space comprises:
allocating the required storage space for the write; and
updating a provisioning map with the allocated storage space.

19. The computer program product of claim 17, wherein the reservation of the required storage space is completed in a batch reserve for a plurality of required storage spaces.

20. The computer program product of claim 16, the program code further:
receiving the write; and
determining if the logical storage address for the write is allocated.
